(19) United States
(12) Patent Application Publication
(10) Pub. No.: US 2008/0246728 A1
(43) Pub. Date: Oct. 9, 2008

(54) Cursor pointing device with memory card receiving mechanism

(76) Inventor: Ken-Pei Hu, Taipei Hsien (TW)

Correspondence Address: BACON & THOMAS, PLLC, 625 SLATERS LANE, FOURTH FLOOR, ALEXANDRIA, VA, 22314-1176, US

(21) Appl. No.: 11/730,826

(22) Filed: Apr. 4, 2007

(51) Int. Cl. G06F 3/033

(52) U.S. Cl. 345/163

(57) ABSTRACT

The present invention is to provide a cursor pointing device having a memory card receiving mechanism, which is enclosed by a housing including an upper housing, a lower housing, and a space formed in the housing after assembling the upper housing and the lower housing together. A receiving unit is disposed on an underside of the upper housing facing the space and includes one or more receiving slots each adapted to receive a memory card. The upper housing is adapted to either open to expose each receiving slot or close onto the lower housing to conceal each receiving slot. Each memory card is protected by and securely received in the receiving slot. Therefore, a user carrying both the cursor pointing device and the memory card(s) does not need to worry about a possible loss of any memory card due to its compactness, slimness, and lightweight.

### FIELD OF THE INVENTION

The present invention relates to cursor pointing devices and more particularly to such a cursor pointing device (e.g., mouse) having a mechanism for receiving one or more memory cards.

### BACKGROUND OF THE INVENTION

The world has entered into a new era with information technology being progressed rapidly. A variety of digital, electronic products are continually invented and are employed in our daily life. This brings a lot of convenience to both our daily life and work. Further, whether people are satisfied with practicability and convenience of such digital, electronic products is another concern in addition to the fast development of such new products.

Conventionally, a mobile phone or digital camera user has to convert a text file or graphics file into a format compatible with a computer prior to storing and editing same therein. This is because the mobile phone or digital camera does not support the text file or graphics file format. Alternatively, a user has to safely store a text file or graphics file in a computer after editing same therein. Otherwise, it is impossible of editing the text file or graphics file in a different type of computer.

There is a type of portable memory card commercially available. The memory card is advantageous for being compact, slim, and lightweight, and is adapted to operate with one of a great variety of digital, electronic products. Further, no significant weight increase of the digital, electronic product occurs after adding the memory card therein. Thus, a user can conveniently use the memory card. A user may store or carry the memory card when not using same. However, it is often that the memory card may be lost or damaged by pressing because the memory card is, as stated above, compact, slim, and lightweight.

In view of the above, users begin to use a container for containing memory cards. The container can protect the rigid shell of the memory card. Otherwise, the memory card may be damaged due to pressing. Still otherwise, the memory card may be damaged due to a foreign object insertion into a circuit board thereof. However, a user has to buy the container prior to enjoying the benefit of protecting the contained memory card. This can bear a financial burden upon the user. While the container can protect the contained memory card, it is still possible that a user may forget the carried memory card in often times prior to using a different type of computer. Thus, the inventor desires to employ a peripheral device to receive memory card(s) for protection. Thus, a user can carry both the peripheral device and the memory card(s) at the same time. Moreover, the cost of buying an additional container is saved. As a result, the drawback of forgetting a carried memory card prior to using a different type of computer is eliminated and the well-known memory card container can be replaced by the peripheral device.

A conventional cursor pointing device (e.g., mouse) has a shape conformed to the palm. The cursor pointing device still has a significant space after mounting a well-known control circuit and other associated components therein. Thus, it is desirable to fully utilize the space to receive one or more memory cards. As such, a user may safely receive the memory cards in the portable cursor pointing device prior to using a different type of computer. As an end, the memory card is prevented from being lost due to its compactness. Therefore, it is desirable to provide a novel cursor pointing device in order to overcome the above inadequacies.

### SUMMARY OF THE INVENTION

After considerable research and experimentation, a cursor pointing device having a memory card receiving mechanism according to the present invention has been devised so as to overcome the above drawbacks of the prior art including the memory card susceptible to being lost due to its compactness, slimness, and lightweight, and the additional cost of buying a memory card container.

It is an object of the present invention to provide a cursor pointing device having a memory card receiving mechanism for removably receiving one or more memory cards having characteristics including compactness, slimness, and lightweight. By utilizing this cursor pointing device, a user can safely carry both the cursor pointing device and the memory card(s) without worrying a possible loss of the memory card(s) or forgetting to carry the memory card(s).

In one aspect of the present invention the cursor pointing device is enclosed by a housing including an upper housing, a lower housing, and a space formed in the housing after assembling the upper housing and the lower housing together. A receiving unit is disposed on an underside of the upper housing facing the space and includes one or more receiving slots each adapted to receive a memory card. The upper housing is adapted to either open to expose each receiving slot or close onto the lower housing to conceal each receiving slot. Each memory card is protected by and securely received in the receiving slot. Therefore, a user carrying both the cursor pointing device and the memory card(s) does not need to worry about a possible loss of any memory card due to its compactness, slimness, and lightweight.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of cursor pointing device (e.g., mouse) according to the present invention where the housing is open for allowing a memory card to be received therein;

FIG. 2 is a longitudinal sectional view of the cursor pointing device for showing the control circuit board;

FIG. 3 is a side elevation of a second preferred embodiment of cursor pointing device (e.g., mouse) according to the present invention where the housing is open for allowing a memory card to be received therein;

FIG. 4 is a side elevation of a third preferred embodiment of cursor pointing device (e.g., mouse) according to the present invention where the housing is detached for allowing a memory card to be received therein;

FIG. 5 is a side elevation of a fourth preferred embodiment of cursor pointing device (e.g., mouse) according to the present invention where the rear engaging member of the housing is detached for allowing a memory card to be received therein; and

FIG. 6 is a side elevation of a fifth preferred embodiment of cursor pointing device (e.g., mouse) according to the present invention where the rear engaging member of the housing is detached for allowing a memory card to be received therein.

### DETAILED DESCRIPTION OF THE PREFERRED EMBODIMENTS

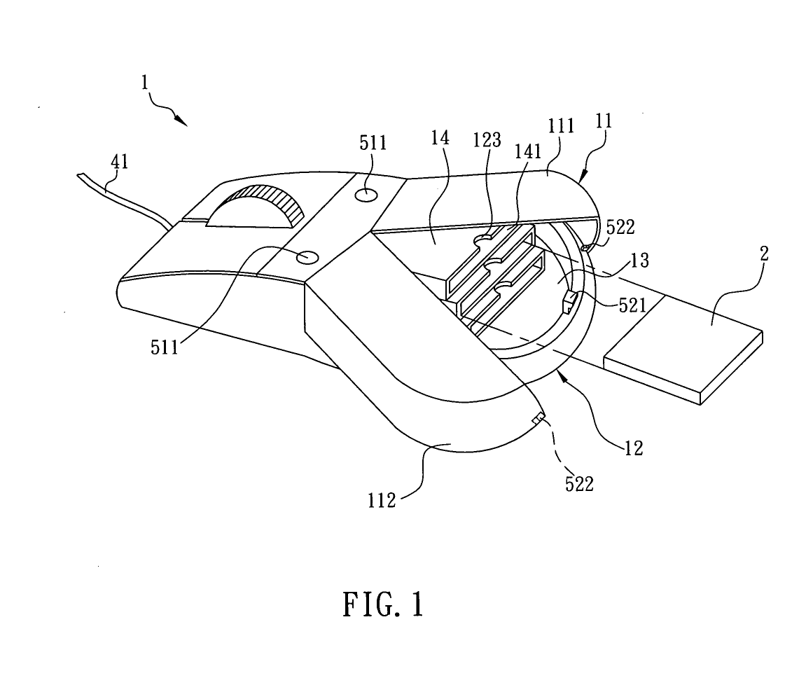

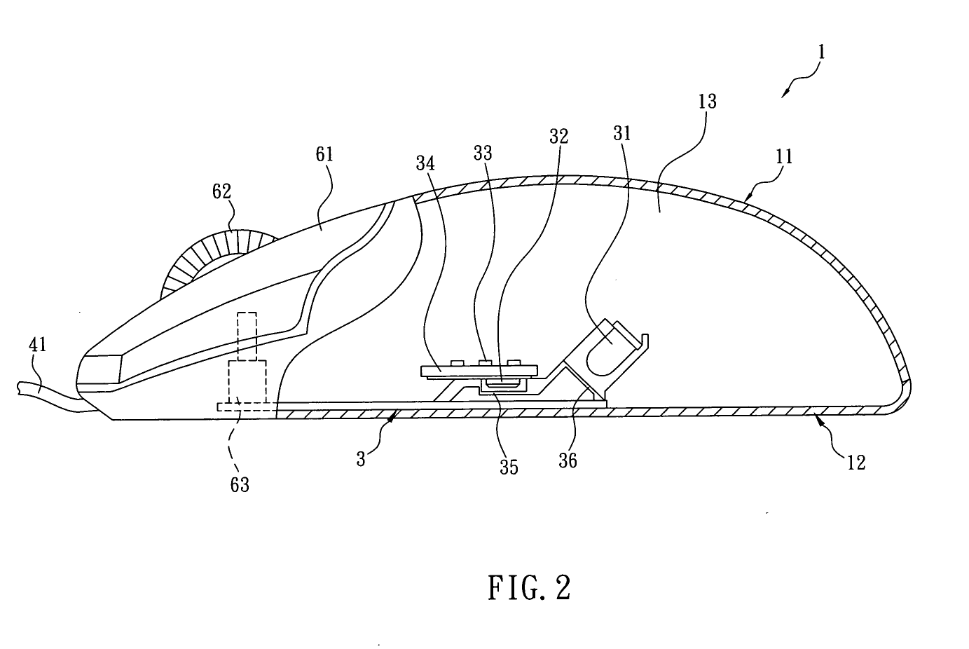

Referring to FIGS. 1 and 2, a cursor pointing device (e.g., mouse) having a memory card receiving mechanism in accordance with a first preferred embodiment of the present invention is shown. The cursor pointing device comprises a housing 1 including an upper housing 11 adapted to open or close, and a lower housing 12. An internal space 13 is formed therein after assembling the upper housing 11 and the lower housing 12 together. A control circuit board 3 is mounted in the space 13 of the housing 1. The control circuit board 3 comprises a light-emitting element (e.g., LED (light-emitting diode)) 31, a video capturer 32, a DSP (digital signal processor) 33, and a logic layer 34. Light emitted from the light-emitting element 31 passes a mould lens 36 integrally formed with a prism 35 prior to impinging on a top surface the lower housing 12. Next, the video capturer 32 gathers light pulses from the top surface of the lower housing 12. Next, the DSP 33 and the logic layer 34 process the light pulses to convert to X and Y displacements. Further, a cable 41 is extended from the DSP 33 through the control circuit board 3 and the lower housing 12 to the external. The cable 41 is adapted to connect to a computer (not shown) by means of a connector (e.g., USB connector or PS2 connector (not shown)). As an end, a corresponding movement of a cursor on a monitor of the computer representing a result of the X and Y displacements is made.

A receiving unit 14 is provided on an underside of the upper housing 11 facing the space 13. The receiving unit 14 comprises a plurality of rectangular receiving slots 141 stacked together as stairs with their openings facing the same direction (i.e., a rear end of the housing 1). Each receiving slot 141 is adapted to receive a memory card 2. The upper housing 11 is adapted to open or close. Openings of the receiving slots 141 are exposed when the upper housing 11 is open. Thus, a user can place a memory card 2 in any one of the receiving slots 141. To the contrary, the user may close the upper housing 11 (i.e., the housing 1 is closed) after removing the memory card 2 from the receiving slot 141. As such, the receiving slots 141 are concealed by the housing 1. By configuring as above, any memory card 2 received in the cursor pointing device is well protected when a user carries the cursor pointing device. In other words, the received memory card 2 is prevented from being lost due to its compactness and lightweight as experienced by the prior art.

Referring to FIG. 1 again, in the first preferred embodiment of the present invention the upper housing 11 comprises a first shield member 111 adapted to open or close, and a second shield member 112 adapted to open or close. Each of the first shield member 111 and the second shield member 112 is equipped with a first pivot pin 511 pivotably secured to top and bottom surfaces of the upper housing 11. The receiving unit 14 is provided under the upper housing 11 proximate the first pivot pins 151 such that the first shield member 111 and the second shield member 112 may either pivot away each other to expose the receiving unit 14 or pivot toward each other until engaging to conceal the receiving unit 14. A first latch 521 is provided on a rear end of the lower housing 12 distal the front cable 41. A second latch 522 is provided on the first shield member 111 distal the first pivot pins 151 and a second latch 522 is provided on the second shield member 112 distal the first pivot pins 151 respectively. Each second latch 522 is a mated component of the first latch 521. Thus, the second latches 522 are secured to the first latch 521 after pivoting the first shield member 111 and the second shield member 112 toward each other to engage. As a result, both the first shield member 111 and the second shield member 112 are secured to the upper housing 11 when a user either carries the cursor pointing device or uses same.

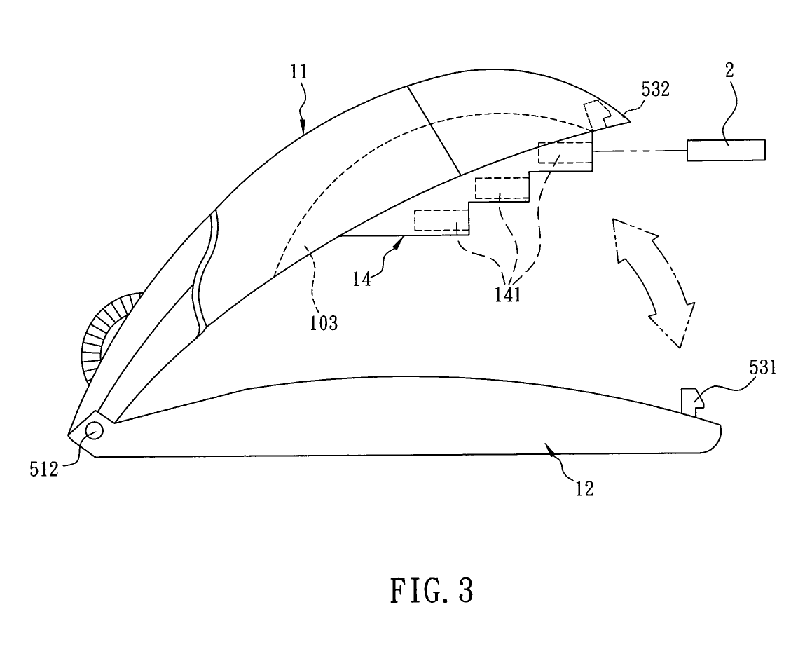

Referring to FIG. 3, a cursor pointing device having a memory card receiving mechanism in accordance with a second preferred embodiment of the present invention is shown. One end (e.g., front end) of the upper housing 11 is pivotably secured to the lower housing 12 by means of at least one second pivot pin 512. A recess 103 is provided on an underside of the upper housing 11 facing the a top of the lower housing 12. The receiving unit 14 is provided in the recess 103. Each receiving slot 141 has an opening distal and opposite the second pivot pin 512. After counterclockwise pivoting the upper housing 11 about the second pivot pin 512 relative to the lower housing 12 a predetermined angle (i.e., pivoting away from the lower housing 12), a user may remove a memory card 2 from the receiving slot 141. After the removal, the user may clockwise pivot the upper housing 11 about the second pivot pin 512 relative to the lower housing 12 until the upper housing 11 engages with the lower housing 12 in order to conceal the receiving unit 14. Moreover, a first latching member 531 is provided on a rear end of the lower housing 12 distal the front second pivot pin 512. A second latching member 532 is provided on a rear end of the upper housing 11 and corresponds to the first latching member 531. The second latching member 532 is a mated component of the first latching member 531. Thus, the second latching member 532 is secured to the first latching member 531 after closing the upper housing 11 onto the lower housing 12. As a result, the upper housing 11 is secured to the lower housing 12 when a user either carries the cursor pointing device or uses same.

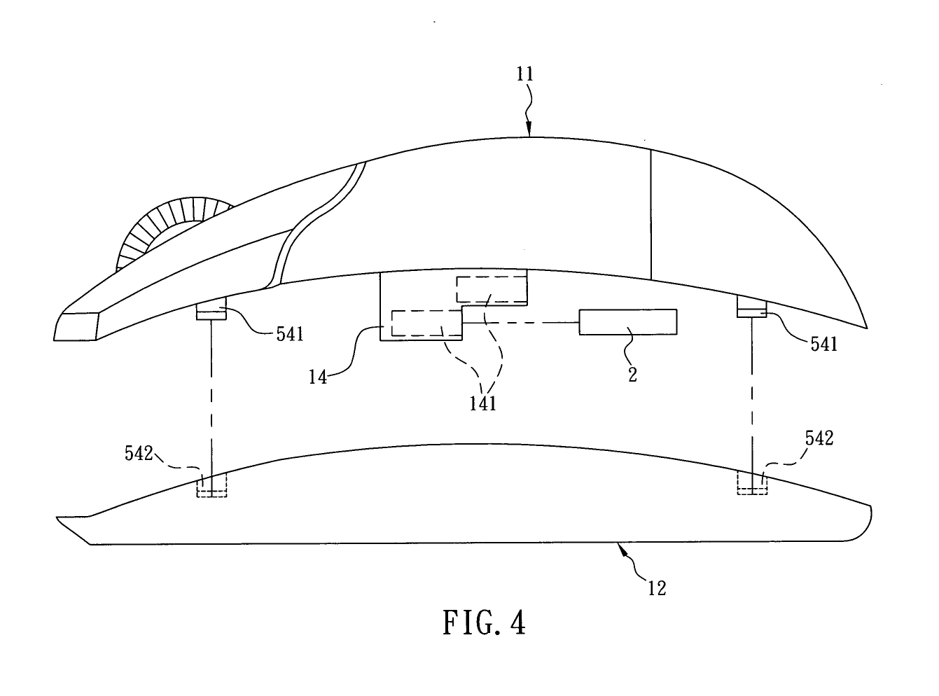

Referring to FIG. 4, a cursor pointing device having a memory card receiving mechanism in accordance with a third preferred embodiment of the present invention is shown. Two tabs 541 are provided at either side of the upper housing 11. Correspondingly, two holes 542 are provided at either side of the lower housing 12. The holes 542 are mated components of the tabs 541. Thus, the tabs 541 are adapted to insert into the holes 542 for fastening the upper housing 11 and the lower housing 12 together. The receiving unit 14 is provided on an underside of the upper housing 11 facing a top of the lower housing 12. The receiving unit 14 comprises a plurality of rectangular receiving slots 141 shaped as stairs. In use, a user may pull two sides of the upper housing 11 relative to the lower housing 12 by the hand until the tabs 541 disengage with the holes 542 (i.e., the upper housing 11 and the lower housing 12 are separate). Thereafter, a user may insert a memory card 2 into the receiving slot 141 of remove a memory card 2 from the receiving slot 141.

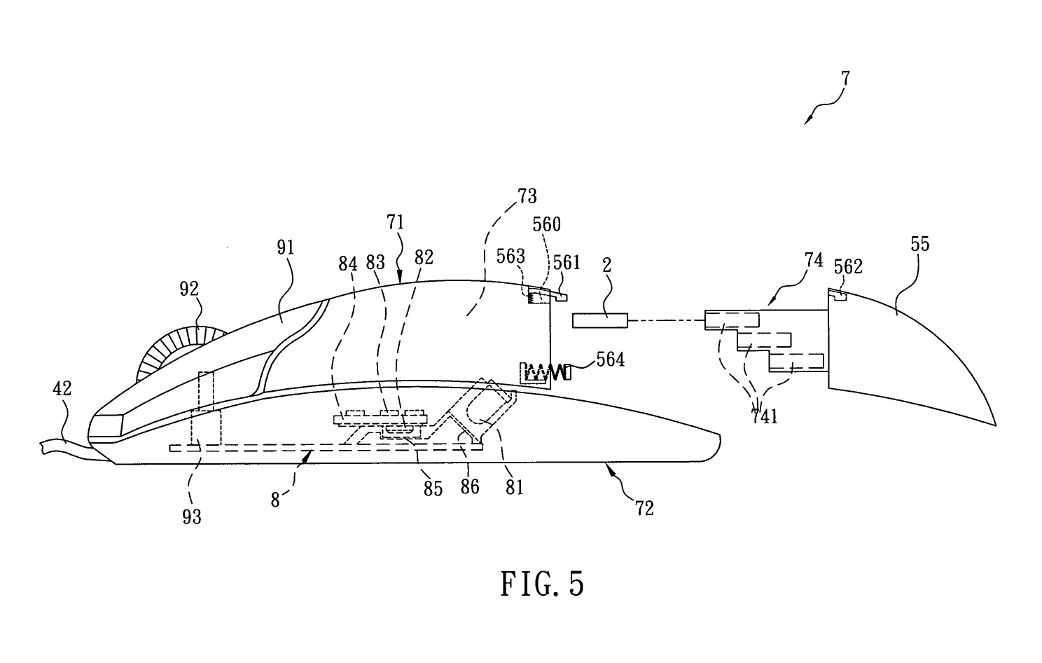

Referring to FIG. 5, a cursor pointing device having a memory card receiving mechanism in accordance with a fourth preferred embodiment of the present invention is shown. The cursor pointing device comprises a housing 7 including an upper housing 71, a rear engaging member 55, and a lower housing 72. An internal space 73 is formed therein after assembling the upper housing 71, the lower housing 72, and the engaging member 55 together. A control circuit board 8 is mounted in the space 73 of the housing 7. The control circuit board 8 comprises a light-emitting element (e.g., LED) 81, a video capturer 82, a DSP 83, and a logic layer 84. Light emitted from the light-emitting element 81 passes a mould lens 86 integrally formed with a prism 85 prior to impinging on a top surface the lower housing 72. Next, the video capturer 82 gathers light pulses from the top surface of the lower housing 72. Next, the DSP 83 and the logic layer 84 process the light pulses to convert to X and Y displacements. Further, a cable 42 is extended from the DSP 83 through the control circuit board 8 and the lower housing 72 to the external. The cable 42 is adapted to connect to a computer (not shown) by means of a connector (e.g., USB connector or PS2 connector (not shown)). As an end, a corresponding movement of a cursor on a monitor of the computer representing a result of the X and Y displacements is made.

Referring to FIG. 5 again, the detachable engaging member 55 comprises a receiving unit 74 projected from its front end. The upper housing 71 has a length less than that of the lower housing 72. Hence, an opening is formed on the housing 7 after assembling the upper housing 71 and the lower housing 72 together. The engaging member 55 is adapted to fill the opening to together with the upper housing 71 and the lower housing 72 form a complete housing 7. The receiving unit 74 is disposed in the space 73 when the complete housing 7 is formed (i.e., the receiving unit 74 is concealed by the housing 7). The receiving unit 74 is exposed after detaching the engaging member 55 from the housing 7. Thereafter, a user may insert a memory card 2 into one of a plurality of receiving slots 741 of the receiving unit 74 of remove a memory card 2 from same.

A slot 560 is formed on a rear end of the upper housing 71 proximate a front end of the engaging member 55. A pivotal lock tab 561 is provided in the slot 560 of the upper housing 71. Thus, the lock tab 561 is adapted to pivot in the slot 560. A first elastic member 563 is provided in a blind end of the slot 560 and is biased against a front end of the lock tab 561. A hole 562 is provided in the front end of the engaging member 55 and corresponds to the lock tab 561. The hole 562 is a mated component of the lock tab 561. Thus, the lock tab 561 is adapted to insert into the hole 562 for locking therein. To the contrary, a user may press a front end of the lock tab 561 distal the engaging member 55 to clear the hole 562. A second elastic member 564 is provided in the upper housing 71 below the first elastic member 563 and faces the front end of the engaging member 55. The second elastic member 564 will be compressed after assembling the engaging member 55 and the upper housing 71 together.

After assembling the engaging member 55, the upper housing 71, and the lower housing 72 together, the second elastic member 564 is compressed by the engaging member 55. Also, the engaging member 55 is prevented from detaching from the upper housing 71 by the compressed second elastic member 564 because the lock tab 561 is locked in the hole 562. For detaching the engaging member 55 from the upper housing 71, a user may press the front end of the lock tab 561 distal the engaging member 55 to disengage with the hole 562. Thereafter, the energized second elastic member 564 pushes the engaging member 55 out of the upper housing 71 and the lower housing 72. Next, a user may insert a memory card 2 into the receiving slot 741 of remove a memory card 2 from same.

Referring to FIG. 5 again, in the fourth preferred embodiment of the present invention the receiving unit 74 comprises one or more receiving slots 741. For example, as shown in FIG. 5, the plurality of receiving slots 741 are stacked together as stairs with their openings facing the same direction (i.e., opposite the front end of the engaging member 55). Each receiving slot 741 is adapted to receive a memory card 2.

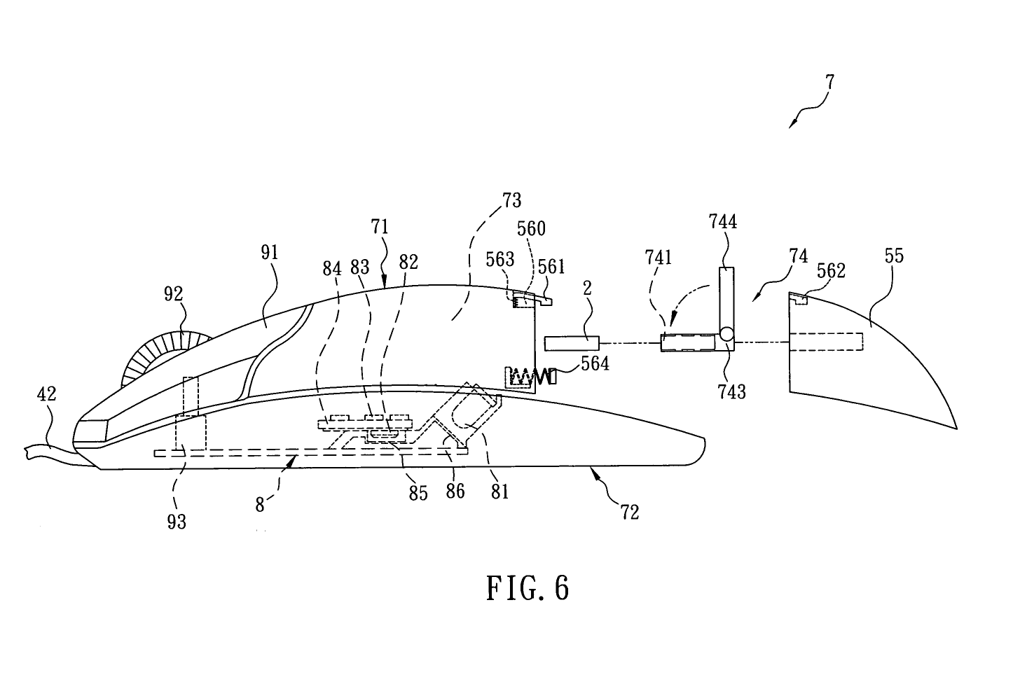

Referring to FIG. 6, a cursor pointing device having a memory card receiving mechanism in accordance with a fifth preferred embodiment of the present invention is shown. The receiving unit 74 is implemented as a memory card case which is releasably provided in the engaging member 55. The memory card case comprises a casing member 743 and a cover 744 hingedly connected to the casing member 743. At least one memory card 2 is adapted to receive in the casing member 743. After placing a memory card 2 in the memory card case, a user may close the cover 744 onto the casing member 743 for receiving the memory card 2 in the memory card case.

Referring to FIG. 1 again, in the preferred embodiments of the present invention an arcuate indentation 123 is formed on a rear top edge of each receiving slot 141. A portion of a top of a memory card 2 is exposed through the indentation 123 after inserting the memory card 2 into the receiving slot 141. The provision of the indentation 123 facilitates a removal of the memory card 2 from the receiving slot 141.

Referring to FIGS. 2 and 5 again, a scroll wheel 62 is partially projected from a front depressible button 61 of the upper housing 11 proximate the cable 41 (see FIG. 2) and a scroll wheel 92 is partially projected from a front depressible button 91 of the upper housing 71 proximate the cable 42 (see FIG. 5) respectively. The depressible button 61 faces a push button 63 on the control circuit board 3 after assembling the upper housing 11 and the lower housing 12 together (see FIG. 2) and the depressible button 91 faces a push button 93 on the control circuit board 8 after assembling the upper housing 71 and the lower housing 72 together (see FIG. 5) respectively. A first signal is generated by the control circuit board 3 after pressing the depressible button 61 and the first signal is then sent to the computer. Likewise, a first signal is generated by the control circuit board 8 after pressing the depressible button 91 and the first signal is then sent to the computer. The scroll wheel 62 is rotatably provided on the depressible button 61 (see FIG. 2) and the scroll wheel 92 is rotatably provided on the depressible button 91 (see FIG. 5) respectively. One side of the scroll wheel 62 inside housing 1 is in gear mesh with a control gear (not shown) on the control circuit board 3 and one side of the scroll wheel 92 inside housing 7 is in gear mesh with a control gear (not shown) on the control circuit board 8 respectively. A second signal is generated by the control circuit board 3 after turning the scroll wheel 62 and the second signal representing a result of X and Y displacements of the turning is then sent to the computer. Likewise, a second signal is generated by the control circuit board 8 after turning the scroll wheel 92 and the second signal representing a result of X and Y displacements of the turning is then sent to the computer. Constructions and operations of the control gear, the push button 63 or 83, and the control circuit board 3 or 8 are well known in the art and a detailed description thereof is therefore deemed unnecessary.

While the invention herein disclosed has been described by means of specific embodiments, numerous modifications and variations could be made thereto by those skilled in the art without departing from the scope and spirit of the invention set forth in the claims.

What is claimed is:

1. A cursor pointing device comprising:
a housing including an upper housing, a lower housing, and a space formed in the housing after assembling the upper housing and the lower housing together;
a control circuit board disposed in the space for controlling a movement of a cursor on a video display screen; and
a receiving unit disposed on an underside of the upper housing facing the space and including one or more receiving slots each adapted to receive a memory card, wherein the upper housing is adapted to either open to expose each receiving slot or close onto the lower housing to conceal each receiving slot.

2. The cursor pointing device of claim 1, wherein the receiving slots are stacked together as stairs with their openings facing the same direction.

3. The cursor pointing device of claim 2, wherein each receiving slot comprises an indentation on a rear edge such that a portion of the memory card is exposed through the indentation after inserting the memory card into the receiving slot.

4. The cursor pointing device of claim 1, wherein the upper housing comprises a first shield member adapted to open or close and a second shield member adapted to open or close, each of the first shield member and the second shield member including a first pivot pin pivotably secured to top and bottom surfaces of the upper housing; and wherein the receiving unit is disposed proximate the first pivot pins such that the first shield member and the second shield member are adapted to either pivot away each other to expose the receiving unit or pivot toward each other until engagement to conceal the receiving unit.

5. The cursor pointing device of claim 3, wherein the upper housing comprises a first shield member adapted to open or close and a second shield member adapted to open or close, each of the first shield member and the second shield member including a first pivot pin pivotably secured to top and bottom surfaces of the upper housing; and wherein the receiving unit is disposed proximate the first pivot pins such that the first shield member and the second shield member are adapted to either pivot away each other to expose the receiving unit or pivot toward each other until engagement to conceal the receiving unit.

6. The cursor pointing device of claim 4, wherein the lower housing comprises a first latch on a rear end distal the first pivot pins; and wherein each of the first shield member and the second shield member comprises a second latch distal the first pivot pins and, each second latch being mated with the first latch such that the second latches are secured to the first latch in response to pivoting the first shield member and the second shield member toward each other to engage.

7. The cursor pointing device of claim 5, wherein the lower housing comprises a first latch on a rear end distal the first pivot pins; and wherein each of the first shield member and the second shield member comprises a second latch distal the first pivot pins and, each second latch being mated with the first latch such that the second latches are secured to the first latch in response to pivoting the first shield member and the second shield member toward each other to engage.

8. The cursor pointing device of claim 1, further comprising at least one second pivot pin disposed at a front end of the upper housing, the second pivot pin being adapted to pivotably secure the upper housing and the lower housing together, and a recess formed on the underside of the upper housing facing the lower housing for receiving the receiving unit; and wherein each receiving slot has an opening distal and opposite the second pivot pin such that either pivoting the upper housing away from the lower housing a predetermined angle will expose each receiving unit or pivoting the upper housing toward the lower housing until engagement will conceal each receiving unit.

9. The cursor pointing device of claim 3, further comprising at least one second pivot pin disposed at a front end of the upper housing, the second pivot pin being adapted to pivotably secure the upper housing and the lower housing together, and a recess formed on the underside of the upper housing facing the lower housing for receiving the receiving unit; and wherein each receiving slot has an opening distal and opposite the second pivot pin such that either pivoting the upper housing away from the lower housing a predetermined angle will expose each receiving unit or pivoting the upper housing toward the lower housing until engagement will conceal each receiving unit.

10. The cursor pointing device of claim 8, further comprising a first latching member disposed on a rear end of the lower housing distal the front second pivot pin, and a second latching member disposed on a rear end of the upper housing, and wherein the second latching member is mated with the first latching member such that the second latching member is adapted to secure to the first latching member in response to closing the upper housing onto the lower housing.

11. The cursor pointing device of claim 9, further comprising a first latching member disposed on a rear end of the lower housing distal the front second pivot pin, and a second latching member disposed on a rear end of the upper housing, and wherein the second latching member is mated with the first latching member such that the second latching member is adapted to secure to the first latching member in response to closing the upper housing onto the lower housing.

12. The cursor pointing device of claim 1, further comprising at least one tab formed at either side of the upper housing, and at least one hole formed at either side of the lower housing, and wherein each hole is mated with each tab such that each tab is adapted to insert into each hole for fastening the upper housing and the lower housing together; and wherein the receiving unit is disposed on the underside of the upper housing facing the lower housing.

13. The cursor pointing device of claim 3, further comprising at least one tab formed at either side of the upper housing, and at least one hole formed at either side of the lower housing, and wherein each hole is mated with each tab such that each tab is adapted to insert into each hole for fastening the upper housing and the lower housing together; and wherein the receiving unit is disposed on the underside of the upper housing facing the lower housing.

14. A cursor pointing device comprising a housing having a memory card receiving mechanism, the housing including:
a lower housing;
an upper housing having a length less than that of the lower housing and adapted to assemble with the lower housing to form an opening on the housing;
a rear engaging member adapted to assemble with the upper housing and the lower housing to form the housing having a space therein, the engaging member including a receiving unit projected from its front end, the receiving unit being disposed and received in the space when the housing is formed; and
a control circuit board disposed in the space for controlling a movement of a cursor on a video display screen.

15. The cursor pointing device of claim 14, further comprising a slot formed on a rear end of the upper housing proximate a front end of the engaging member, a pivotal lock tab disposed in the slot of the upper housing, the lock tab adapted to pivot in the slot, and a hole formed in the front end of the engaging member, and wherein the hole is mated with the lock tab such that the lock tab is adapted to either insert into the hole for locking therein or clear the hole by pressing a front end of the lock tab distal the engaging member.

16. The cursor pointing device of claim 15, further comprising a first elastic member disposed in a blind end of the slot and biased against the front end of the lock tab distal the engaging member.

17. The cursor pointing device of claim 15, further comprising a second elastic member disposed in the upper housing below the first elastic member and faced the front end of the engaging member, the second elastic member adapted to compress in response to assembling the engaging member and the upper housing together.

18. The cursor pointing device of claim 14, wherein the receiving unit comprises one or more receiving slots each adapted to receive a memory card.

19. The cursor pointing device of claim 18, wherein the receiving slots are stacked together as stairs with their openings facing the same direction.

20. The cursor pointing device of claim 14, wherein the receiving unit is releasably disposed in the engaging member.

21. The cursor pointing device of claim 20, wherein the receiving unit is a memory card case.

22. The cursor pointing device of claim 21, wherein the memory card case comprises a casing member and a cover hingedly connected to the casing member.

23. The cursor pointing device of claim 22, wherein the casing member is adapted to receive at least one memory card.
